(19) United States
(12) Patent Application Publication
(10) Pub. No.: US 2025/0313483 A1
(43) Pub. Date: Oct. 9, 2025

(54) METHOD FOR PREPARING DIIODOSILANE

(71) Applicant: DNF CO., LTD., Daejeon (KR)

(72) Inventors: Se Jin JANG, Daejeon (KR); Jong Moon KIM, Daejeon (KR); Jeong Joo PARK, Daejeon (KR); Youngjae IM, Daejeon (KR)

(21) Appl. No.: 19/090,869

(22) Filed: Mar. 26, 2025

(30) Foreign Application Priority Data
Apr. 5, 2024 (KR) 10-2024-0046755
Jul. 16, 2024 (KR) 10-2024-0093461

(51) Int. Cl. C01B 33/107

(52) U.S. Cl. CPC C01B 33/10778

(57) ABSTRACT

Provided is a method for preparing diiodosilane including: reacting a compound represented by the following Chemical Formula 1 with iodine (I₂) to prepare diiodosilane (SiH₂I₂), and the method may secure process safety and productivity and provide high-purity diiodosilane:

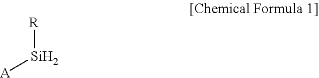

wherein R and A are as defined in the specification.

### CROSS-REFERENCE TO RELATED APPLICATIONS

This application claims priority under 35 U.S.C. § 119 to Korean Patent Application No. 10-2024-0046755, filed on Apr. 5, 2024, and to Korean Patent Application No. 10-2024-0093461, filed on Jul. 16, 2024, the disclosure of which have been incorporated herein by reference in their entirety.

### TECHNICAL FIELD

The following disclosure relates to a method for preparing diiodosilane.

### BACKGROUND

Diiodosilane (SiH₂I₂) is a compound which plays an important role in the fields of semiconductor manufacturing and new material development, and the demand for the compound is increasing with the continuous development of the semiconductor industry.

In the conventional technology, a synthesis method in which a Si—Cl bond of diiodosilane (SiH₂Cl₂) is substituted with Si—I using expensive lithium iodide and the like has been mainly used in order to synthesize diiodosilane. However, since dichlorosilane as a raw material is a flammable material which is a gas at room temperature and reacts with moisture to produce hydrogen chloride gas which is a toxic material, special care is required during storage.

Meanwhile, a synthesis method in which phenylsilane is reacted with iodine to prepare diiodosilane has been suggested, but phenylsilane as a raw material is an expensive material to reduce productivity, causes explosion on contact with moisture, and easily absorbs moisture, and thus, it is difficult to store it. In addition, since there is a risk of explosion due to severe heat during a reaction process, process risk is high, yield reduction is caused, and benzene which is a carcinogen is produced as a reaction by-product.

### RELATED ART DOCUMENTS

### Patent Document

(Patent Document 1) US 2016-0264426 A1

### SUMMARY

An embodiment of the present invention is directed to providing a preparation method for obtaining high-purity diiodosilane while simultaneously securing process safety and productivity.

In one general aspect, a method for preparing diiodosilane includes: reacting a compound represented by the following Chemical Formula 1 with iodine (I₂) to prepare diiodosilane (SiH₂I₂):

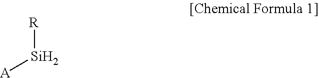

wherein
R is hydrogen or —NR¹R²;
R¹ and R² are independently of each other hydrogen or C1-C10 alkyl;
A is —NR³R⁴ or —OR⁵;
R³ to R⁵ are independently of one another hydrogen, C1-C10 alkyl, C6-C12 aryl, or —SiR¹¹R¹²R¹³; and R³ and R⁴ may be connected by C3-C7 alkylene or C2-C7 heteroalkylene to form a heterocycle;
the heterocycle and the alkyl of R³ to R⁵ may be substituted by —SiR¹⁴R¹⁵R¹⁶ or —OSiR¹⁷R¹⁸R¹⁹; and
R¹¹ to R¹⁹ are independently of one another hydrogen or C1-C10 alkyl.

The compound represented by Chemical Formula 1 may be represented by the following Chemical Formula 2 or 3:

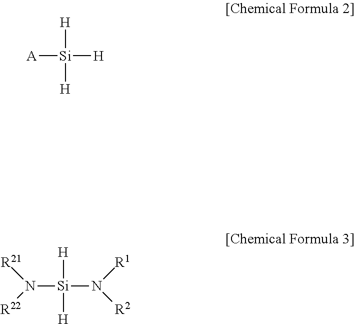

wherein
A, R¹, and R² are as defined in Chemical Formula 1 above;
R²¹ and R₂₂ are independently of each other hydrogen, C1-C10 alkyl, C6-C12 aryl, or —SiR¹¹R¹²R¹³; and
R¹¹ to R¹³ are independently of one another hydrogen or C1-C10 alkyl.
R¹, R², R²¹, and R²² may be independently of one another hydrogen or C1-C4 alkyl.
R⁵ may be C1-C10 alkyl or -L1-OSiR¹⁷R¹⁸R¹⁹; L1 may be C1-C10 alkylene; and R¹⁷ to R¹⁹ may be independently of one another hydrogen or C1-C10 alkyl.

The compound represented by Chemical Formula 2 may be represented by the following Chemical Formula 4 or 5:

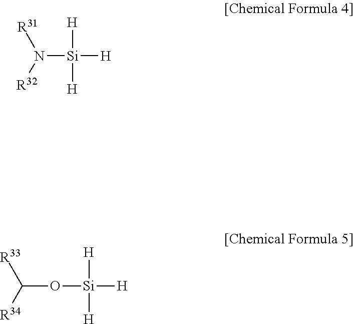

wherein
R³¹ and R³² are independently of each other hydrogen, C1-C7 alkyl, C6-C12 aryl, or —SiR¹¹R¹²R¹³,
R³¹ and R³² may be connected by C3-C7 alkylene or *-L²-X¹-L³-* to form a heterocycle;
L² and L³ are independently of each other C1-C3 alkylene;
X¹ is a single bond, —O—, or —NR³⁵;
R³⁵ is hydrogen or —SiR¹⁴R¹⁵R¹⁶;
R³³ is C1-C4 alkyl;
R³⁴ is C1-C4 alkyl or —OSiR¹⁷R¹⁸R¹⁹; and
R¹¹ to R¹⁹ are independently of one another hydrogen or C1-C7 alkyl.

The compound represented by Chemical Formula 1 may be selected from the following structures:

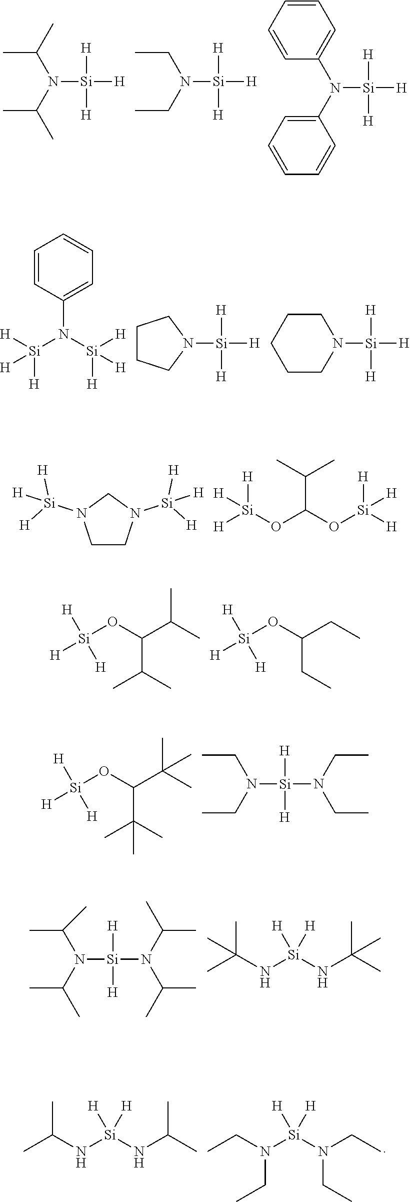

The method for preparing diiodosilane according to an exemplary embodiment may further include reacting hydrogen iodide (HI).

The reaction may be performed in the presence of a mixed solvent including an ester-based organic solvent and a halogenated hydrocarbon-based organic solvent.

The reaction may be performed under a temperature condition of 10 to 40° C.

The method for preparing diiodosilane according to an exemplary embodiment may further include filtering an iodic acid salt and performing distillation and purification, after the reaction.

Other features and aspects will be apparent from the following detailed description, the drawings, and the claims.

### DETAILED DESCRIPTION OF EMBODIMENTS

In the present specification, unless otherwise defined, all technical terms and scientific terms have the same meanings as those commonly understood by a person skilled in the art to which the present invention pertains. The terms used herein are only for effectively describing a certain specific example, and are not intended to limit the present invention.

The singular form used in the present specification may be intended to also include a plural form, unless otherwise indicated in the context.

Throughout the present specification, unless otherwise particularly stated, the word “comprise”, “equipped”, “contain”, or “have” does not mean the exclusion of any other constituent element, but means further inclusion of other constituent elements, and elements, materials, or processes which are not further listed are not excluded.

The numerical range used in the present specification includes all values within the range including the lower limit and the upper limit, increments logically derived from the form and spanning of a defined range, all double limited values, and all possible combinations of the upper limit and the lower limit in the numerical range defined in different forms. Unless otherwise defined in the present specification, values which may be outside a numerical range due to experimental error or rounding off of a value are also included in the defined numerical range.

The term “alkyl” in the present specification is an organic radical derived from an aliphatic hydrocarbon by removal of one hydrogen, and may include both a straight chain and branched chain forms. As an example, it may include methyl, ethyl, propyl, isopropyl, butyl, isobutyl, t-butyl, pentyl, hexyl, ethylhexyl, and the like, but is not limited thereto.

The term “alkylene” in the present specification is a divalent organic radical derived from an aliphatic hydrocarbon by removal of two hydrogens, and may include both straight chain and branched chain forms. As an example, it includes methylene, ethylene, propylene, isopropylene, butylene, isobutylene, t-butylene, pentylene, hexylene, octylene, nonylene, and the like, but is not limited thereto.

The term “heteroalkylene” of the present specification refers to alkylene including one or more heteroatoms selected from B, N, O, S, P(═O), Si, and P, and the alkylene is as defined above.

The term “aryl” in the present specification refers to an organic radical derived from an aromatic hydrocarbon by removal of one hydrogen and includes a monocyclic or fused cyclic system including suitably 4 to 7, preferably 5 or 6 ring atoms in each ring and includes even a form in which a plurality of aryls are connected by a single bond. As an example, it includes phenyl, naphthyl, biphenyl, fluorenyl, and the like, but is not limited thereto.

Unless otherwise particularly defined in the present specification, “about” may be considered as a value within 30%, 25%, 20%, 15%, 10%, or 5% of a stated value.

Hereinafter, the present disclosure will be described in detail. However, it is only illustrative and the present disclosure is not limited to the specific exemplary embodiment which is illustratively described.

An exemplary embodiment of the present invention provides a preparation method for obtaining high-purity diiodosilane while simultaneously securing process safety and productivity.

Specifically, the method for preparing diiodosilane according to an exemplary embodiment may include: reacting a compound represented by the following Chemical Formula 1 with iodine (I₂) to prepare diiodosilane (SiH₂I₂):

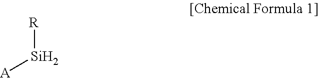

wherein
R is hydrogen or —NR¹R²;
R¹ and R² are independently of each other hydrogen or C1-C10 alkyl;
A is —NR³R⁴ or —OR⁵;
R³ to R⁵ are independently of one another hydrogen, C1-C10 alkyl, C6-C12 aryl, or —SiR¹¹R¹²R¹³; and R³ and R⁴ may be connected by C3-C7 alkylene or C2-C7 heteroalkylene to form a heterocycle;
the heterocycle and the alkyl of R³ to R⁵ may be substituted by —SiR¹⁴R¹⁵R¹⁶ or —OSiR¹⁷R¹⁸R¹⁹; and
R¹¹ to R¹⁹ are independently of one another hydrogen or C1-C10 alkyl.

As an example, R¹ and R² may be independently of each other hydrogen or C1-C7 alkyl, specifically hydrogen or C1-C4 alkyl.

As an example, R³ and R⁴ may be independently of each other hydrogen, C1-C7 alkyl, C6-C12 aryl, or —SiR¹¹R¹²R¹³.

As an example, R³ and R⁴ may be independently of each other hydrogen, C1-C4 alkyl, C6-C12 aryl, or —SiR¹¹R¹²R¹³.

As an example, R¹¹ to R¹³ may be independently of one another hydrogen or C1-C7 alkyl, hydrogen or C1-C4 alkyl, specifically, hydrogen or methyl.

As an example, R³ and R⁴ may be connected by C3-C7 alkylene or *-L²-X¹-L³-* to form a heterocycle; L² and L³ may be independently of each other C1-C3 alkylene; X¹ may be a single bond, —O—, or —NR³⁵; R³⁵ may be hydrogen or —SiR¹⁴R¹⁵R¹⁶; and R¹⁴ to R¹⁶ may be independently of one another hydrogen or C1-C7 alkyl.

As an example, R¹⁴ to R¹⁶ may be independently of one another hydrogen or C1-C4 alkyl, specifically hydrogen or methyl.

The compound represented by Chemical Formula 1 may be represented by the following Chemical Formula 2 or 3:

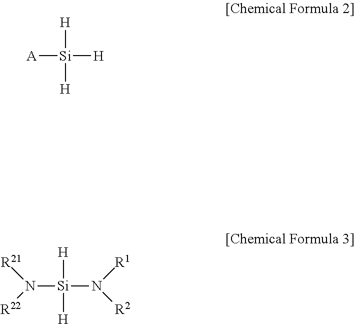

wherein
A, R¹, and R² are as defined in Chemical Formula 1 above;
R²¹ and R₂₂ are independently of each other hydrogen, C1-C10 alkyl, C6-C12 aryl, or —SiR¹¹R¹²R¹³; and
R¹¹ to R¹³ are independently of one another hydrogen or C1-C10 alkyl.

As an example, R²¹ and R₂₂ may be independently of each other hydrogen, C1-C7 alkyl, C6-C12 aryl, or —SiR¹¹R¹²R¹³, and specifically, R²¹ and R₂₂ may be independently of each other hydrogen, C1-C4 alkyl, C6-C12 aryl, or —SiR¹¹R¹²R¹³.

As an example, R¹, R², R²¹, and R²² may be independently of one another hydrogen or C1-C4 alkyl.

As an example, R¹ and R²¹ may be identical to each other and may be hydrogen or C1-C4 alkyl.

As an example, R² and R₂₂ may be identical to each other and may be hydrogen or C1-C4 alkyl.

As an example, R⁵ may be C1-C10 alkyl or -L¹-OSiR¹⁷R¹⁸R¹⁹; L¹ may be C1-C10 alkylene; and R¹⁷ to R¹⁹ may be independently of one another hydrogen or C1-C10 alkyl.

As an example, R⁵ may be branched C3-C10 alkyl or -L¹-OSiR¹⁷R¹⁸R¹⁹; L¹ may be branched C3-10 alkylene; and R¹⁷ to R¹⁹ may be independently of one another hydrogen or C1-C10 alkyl.

As an example, R⁵ may be branched C3-C7 alkyl or -L¹-OSiR¹⁷R¹⁸R¹⁹; L¹ may be branched C3-7 alkylene; and R¹⁷ to R¹⁹ may be independently of one another hydrogen or C1-C7 alkyl.

As an example, R¹⁷ to R¹⁹ may be independently of one another hydrogen or C1-C4 alkyl, specifically hydrogen or methyl.

The compound represented by Chemical Formula 2 may be represented by the following Chemical Formula 4 or 5:

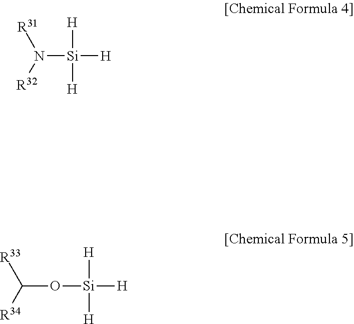

wherein
R³¹ and R³² are independently of each other hydrogen, C1-C7 alkyl, C6-C12 aryl, or —SiR¹¹R¹²R¹³,
R³¹ and R³² may be connected by C3-C7 alkylene or *-L²-X¹-L³-* to form a heterocycle;
L² and L³ are independently of each other C1-C3 alkylene;
X¹ is a single bond, —O—, or —NR³⁵;
R³⁵ is hydrogen or —SiR¹⁴R¹⁵R¹⁶;
R³³ is C1-C4 alkyl;
R³⁴ is C1-C4 alkyl or —OSiR¹⁷R¹⁸R¹⁹; and
R¹¹ to R¹⁹ are independently of one another hydrogen or C1-C7 alkyl.

As an example, R³¹ and R³² may be independently of each other hydrogen, C1-C4 alkyl, C6-C12 aryl, or —SiR¹¹R¹²R¹³.

Specifically, the compound represented by Chemical Formula 1 may be selected from the following structures, but is not limited thereto:

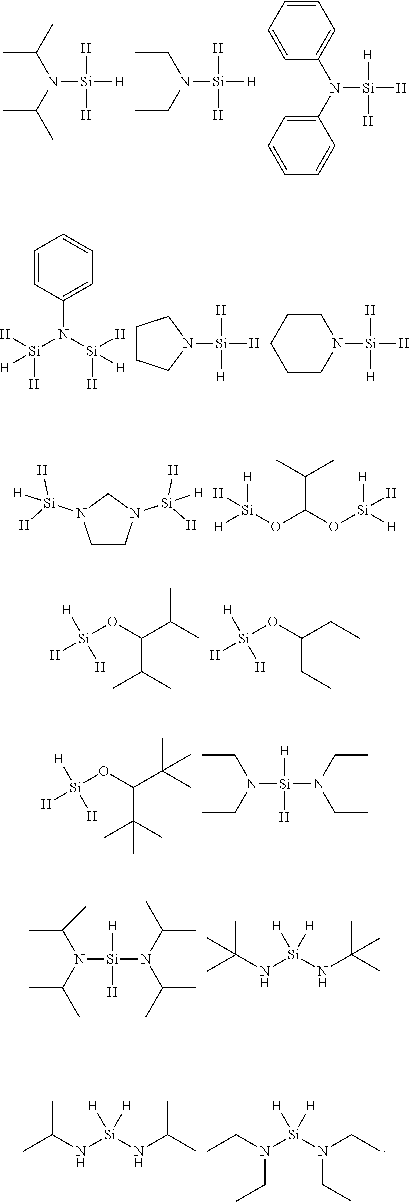

In the preparation method according to an exemplary embodiment, the reaction may be performed in the presence of an organic solvent, and though the organic solvent is not particularly limited as long as it easily dissolves a starting material, it may be, for example, an alcohol-based solvent such as methanol, ethanol, n-propanol, isopropanol, n-butanol, and isobutanol; an ester-based solvent such as ethyl acetate, butyl acetate, and 3-methoxy-3-methyl butyl acetate; an ether-based solvent such as dimethyl ether and dibutyl ether; a ketone-based solvent such as acetone, methyl ethyl ketone, methyl isobutyl ketone, and acetophenon; a halogenated hydrocarbon-based solvent such as dichloromethane, dichloroethane, chloroform, carbon tetrachloride, trichloroethylene, and perfluoropropane; and the like.

Specifically, the reaction may be performed in the presence of a mixed solvent including an ester-based organic solvent and a halogenated hydrocarbon-based organic solvent, and the mixed solvent may include the ester-based organic solvent and the halogenated hydrocarbon-based at a mole ratio of 1:10 to 100, 1:20 to 100, 1:20 to 70, 1:30 to 70, or 1:40 to 70.

The reaction may be performed for 10 to 40 hours, 10 to 30 hours, or 20 to 30 hours under a temperature of 10 to 40° C. or 20 to 40° C.

The method for preparing diiodosilane according to an exemplary embodiment may further include filtering an iodic acid salt and performing distillation and purification, after the reaction.

Specifically, the method for preparing diiodosilane according to an exemplary embodiment may include: adding iodine to a halogenated hydrocarbon-based organic solvent; adding the compound represented by Chemical Formula 1 and an ester-based organic solvent to perform a reaction; and filtering an iodic acid salt produced after the reaction and performing distillation and purification.

The preparation method according to an exemplary embodiment may further include reacting hydrogen iodide (HI), and in this case, it may include adding iodine to a halogenated hydrocarbon-based organic solvent; adding the compound represented by Chemical Formula 1 and an ester-based organic solvent to perform a reaction; bubbling hydrogen iodide and performing further stirring; and filtering an iodic acid salt produced after the reaction and performing distillation and purification.

Hereinafter, the exemplary embodiments described above will be described in detail through the following examples. However, the following examples are only for description, and do not limit the scope of the rights.

### <Synthesis of Diiodosilane>

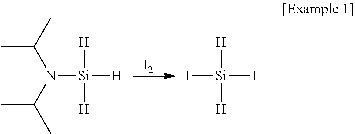

1028 g (4.05 mol) of iodine (diiodine, I₂) and 464 ml (5.79 mol) of chloroform were added to a flame-dried 100 mL flask under an anhydrous and inert atmosphere, a mixture in which 253 g (1.93 mol) of diisopropylaminosilane and 9.5 ml (0.1 mol) of ethyl acetate were mixed was slowly added at an internal temperature between 5° C. and 25° C., and then stirring was performed at room temperature for 24 hours. After completing the reaction, the reaction mixture was filtered to remove diisopropylamine iodide, and the solvent was removed from the obtained filtrate under reduced pressure. The mixed solution was distilled and purified under the conditions of 38 to 40° C. and 8 to 9 torr to obtain 176 g of diiodosilane (yield: 32.13%, NMR purity: 98.72%).

¹H NMR (C₆D₆): 3.57 ppm (s, 2H)

²⁹Si NMR (C₆D₆): −98.8 ppm (s, 1Si)

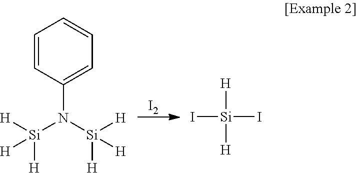

34.8 g (0.14 mol) of iodine (diiodine) and 23.4 g (0.20 mol) of chloroform were added to a flame-dried 100 mL flask under an anhydrous and inert atmosphere, a mixture in which 10 g (0.07 mol) of disilylphenylamine and 0.29 g (0.003 mol) of ethyl acetate were mixed was slowly added at an internal temperature between 5° C. and 30° C., and then stirring was performed at room temperature for 24 hours. After completing the reaction, the reaction mixture was filtered to remove aniline hydroiodide, and the solvent was removed from the obtained filtrate under reduced pressure. The mixed solution was distilled and purified under the conditions of 38 to 40° C. and 8 to 9 torr to obtain 11.9 g of diiodosilane (yield: 32%, NMR purity: 98.13%).

¹H NMR (C₆D₆): 3.57 ppm (s, 2H)

²⁹Si NMR (C₆D₆): −100.1 ppm (s, 1Si)

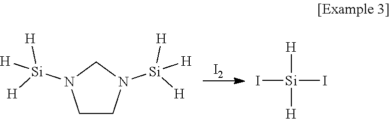

40.3 g (0.16 mol) of iodine (diiodine) and 27.1 g (0.23 mol) of chloroform were added to a flame-dried 100 mL flask under an anhydrous and inert atmosphere, a mixture in which 10 g (0.08 mol) of 1.3-disilylimidazolidine and 0.33 g (0.004 mol) of ethyl acetate were mixed was slowly added at an internal temperature between 5° C. and 30° C., and then stirring was performed at room temperature for 24 hours. After completing the reaction, the reaction mixture was filtered to remove imidazolidine dihydroiodide, and the solvent was removed from the obtained filtrate under reduced pressure. The mixed solution was distilled and purified under the conditions of 38 to 40° C. and 8 to 9 torr to obtain 5.4 g of diiodosilane (yield: 25%).

¹H NMR (C₆D₆): 3.57 ppm (s, 2H)

²⁹Si NMR (C₆D₆): −98.8 ppm (s, 1Si)

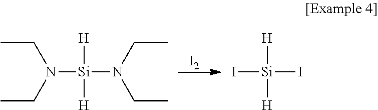

30.6 g (0.12 mol) of iodine (diiodine) and 20.5 g (0.17 mol) of chloroform were added to a flame-dried 100 mL flask under an anhydrous and inert atmosphere, a mixture in which 10 g (0.06 mol) of bis-diethylamino silane and 0.25 g (0.003 mol) of ethyl acetate were mixed was slowly added at an internal temperature between 5° C. and 25° C., and then stirring was performed at room temperature for 24 hours. After completing the reaction, the reaction mixture was filtered to remove diethylamine hydroiodide, and the solvent was removed from the obtained filtrate under reduced pressure. The mixed solution was distilled and purified under the conditions of 30 to 35° C. and 3 to 5 torr to obtain 4.6 g of diiodosilane (yield: 28%).

¹H NMR (C₆D₆): 3.57 ppm (s, 2H)

²⁹Si NMR (C₆D₆): −98.8 ppm (s, 1Si)

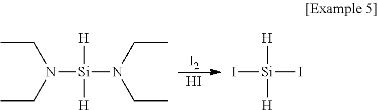

30.6 g (0.12 mol) of iodine (diiodine) and 20.5 g (0.17 mol) of chloroform were added to a flame-dried 100 mL flask under an anhydrous and inert atmosphere, a mixture in which 10 g (0.06 mol) of bis-diethylamino silane and 0.25 g (0.003 mol) of ethyl acetate were mixed was slowly added at an internal temperature between 15° C. and 30° C., and then stirring was performed at room temperature for 12 hours. After cooling to 0° C., 7.3 g (0.06 mol) of hydrogen iodide (HI) was bubbled, and then stirring was performed at room temperature for 2 hours. After completing the reaction, the reaction mixture was filtered to remove diethylamine hydroiodide, and the solvent was removed from the obtained filtrate under reduced pressure. The mixed solution was distilled and purified under the conditions of 30 to 35° C. and 3 to 5 torr to obtain 4.6 g of diiodosilane (yield: 28.8%).

¹H NMR (C₆D₆): 3.50 ppm (s, 2H)

²⁹Si NMR (C₆D₆): −98.8 ppm (s, 1Si)

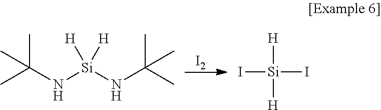

30.6 g (0.12 mol) of iodine (diiodine) and 20.5 g (0.17 mol) of chloroform were added to a flame-dried 100 mL flask under an anhydrous and inert atmosphere, a mixture in which 10 g (0.06 mol) of bis-(tertbutylamino) silane and 0.25 g (0.003 mol) of ethyl acetate were mixed was slowly added at an internal temperature between 5° C. and 25° C., and then stirring was performed at room temperature for 24 hours. After completing the reaction, the reaction mixture was filtered to remove tertbutylamino hydroiodide, and the solvent was removed from the obtained filtrate under reduced pressure. The mixed solution was distilled and purified under the conditions of 30 to 35° C. and 3 to 5 torr to obtain 3.7 g of diiodosilane (yield: 23%).

¹H NMR (C₆D₆): 3.57 ppm (s, 2H)

²⁹Si NMR (C₆D₆): −98.8 ppm (s, 1Si)

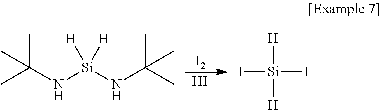

30.6 g (0.12 mol) of iodine (diiodine) and 20.5 g (0.17 mol) of chloroform were added to a flame-dried 100 mL flask under an anhydrous and inert atmosphere, a mixture in which 10 g (0.06 mol) of bis-(tertbutylamino) silane and 0.25 g (0.003 mol) of ethyl acetate were mixed was slowly added at an internal temperature between 15° C. and 30° C., and then stirring was performed at room temperature for 12 hours. After cooling to 0° C., 7.3 g (0.06 mol) of hydrogen iodide (HI) was bubbled, and then stirring was performed at room temperature for 2 hours. After completing the reaction, the reaction mixture was filtered to remove tertbutylamino hydroiodide, and the solvent was removed from the obtained filtrate under reduced pressure. The mixed solution was distilled and purified under the conditions of 30 to 35° C. and 3 to 5 torr to obtain 3.7 g of diiodosilane (yield: 23%).

¹H NMR (C₆D₆): 3.50 ppm (s, 2H)

²⁹Si NMR (C₆D₆): −98.8 ppm (s, 1Si)

Since the preparation method according to an exemplary embodiment uses a starting material which is a liquid at room temperature and is stable, it is easy to store and handle the starting material, and thus, the method is favorable for commercialization.

Since the preparation method according to an exemplary embodiment does not produce excessive heat during the reaction process, process safety is excellent and energy used for cooling may be saved. In addition, the iodic acid salt as a reaction by-product may be safely and easily removed by filtration, and high-purity diiodosilane may be obtained by a simple process.

Hereinabove, although the present invention has been described by specific matters, the examples, and the comparative examples, they have been provided only for assisting in the entire understanding of the present invention, and the present invention is not limited to the above examples. Various modifications and changes may be made by those skilled in the art to which the present invention pertains from this description.

Therefore, the spirit of the present invention should not be limited to the above-described exemplary embodiments, and the following claims as well as all modifications equal or equivalent to the claims are intended to fall within the scope and spirit of the invention.

What is claimed is:

1. A method for preparing diiodosilane, the method comprising:
reacting a compound represented by the following Chemical Formula 1 with iodine (I₂) to prepare diiodosilane (SiH₂I₂): 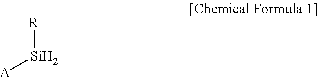
wherein:
R is hydrogen or —NR¹R²;
R¹ and R² are, independently of each other, hydrogen or C1-C10 alkyl;
A is —NR³R⁴ or —OR⁵;
R³ to R⁵ are, independently of one another, hydrogen, C1-C10 alkyl, C6-C12 aryl, —SiR¹¹R¹²R¹³, or R³ and R⁴ may be connected by C3-C7 alkylene or C2-C7 heteroalkylene to form a heterocycle;
the heterocycle and the alkyl of R³ to R⁵ may be substituted by —SiR¹⁴R¹⁵R¹⁶ or —OSiR¹⁷R¹⁸R¹⁹; and
R¹¹ to R¹⁹ are, independently of one another, hydrogen or C1-C10 alkyl.

2. The method for preparing diiodosilane of claim 1, wherein the compound represented by Chemical Formula 1 is represented by the following Chemical Formula 2 or 3: 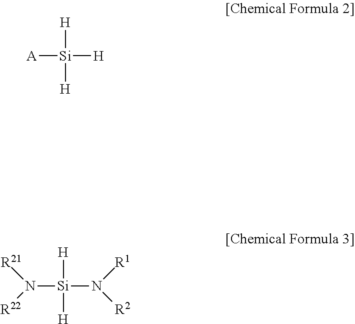
wherein:
A is —NR³R⁴ or —OR⁵;
R¹ and R² are, independently of each other, hydrogen or C1-C10 alkyl;
R²¹ and R₂₂ are, independently of each other, hydrogen, C1-C10 alkyl, C6-C12 aryl, or —SiR¹¹R¹²R¹³; and
R¹¹ to R¹³ are, independently of one another, hydrogen or C1-C10 alkyl.

3. The method for preparing diiodosilane of claim 2, wherein R¹, R², R²¹, and R²² are, independently of one another, hydrogen or C1-C4 alkyl.

4. The method for preparing diiodosilane of claim 1, wherein:
R⁵ is C1-C10 alkyl or -L¹-OSiR¹⁷R¹⁸R¹⁹;
L¹ is C1-C10 alkylene; and
R¹⁷ to R¹⁹ are, independently of one another, hydrogen or C1-C10 alkyl.

5. The method for preparing diiodosilane of claim 2, wherein the compound represented by Chemical Formula 2 is represented by the following Chemical Formula 4 or 5: 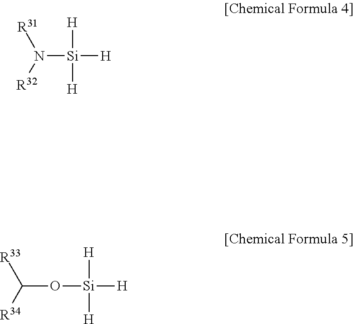
wherein:
R³¹ and R³² are independently of each other hydrogen, C1-C7 alkyl, C6-C12 aryl, —SiR¹¹R¹²R¹³, or R³¹ and R³² may be connected by C3-C7 alkylene or *-L²-X¹-L³-* to form a heterocycle;
L² and L³ are, independently of each other, C1-C3 alkylene;
X¹ is a single bond, —O—, or —NR³⁵;
R³⁵ is hydrogen or —SiR¹⁴R¹⁵R¹⁶;
R³³ is C1-C4 alkyl;
R³⁴ is C1-C4 alkyl or —OSiR¹⁷R¹⁸R¹⁹; and
R¹¹ to R¹⁹ are, independently of one another, hydrogen or C1-C7 alkyl.

6. The method for preparing diiodosilane of claim 1, wherein the compound represented by Chemical Formula 1 is selected from the group consisting of the following structures:

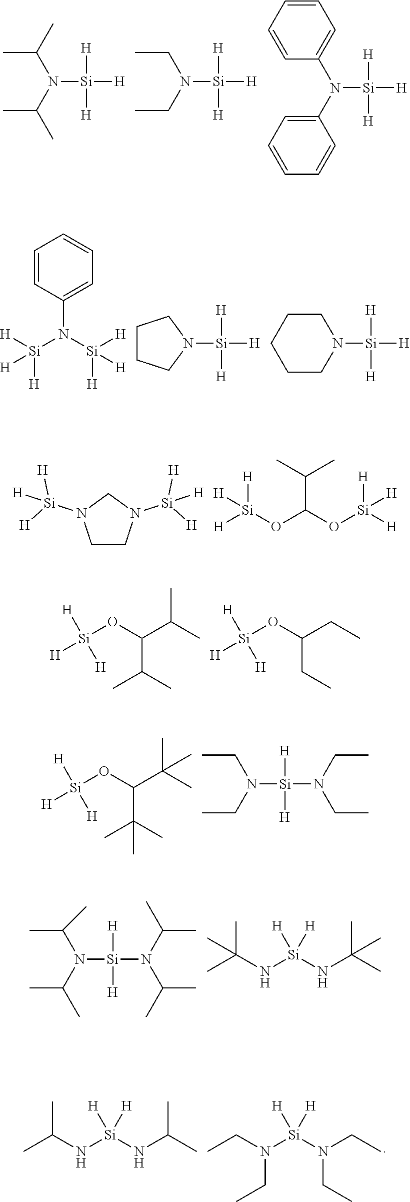

7. The method for preparing diiodosilane of claim 1, further comprising:
reacting the compound represented by the following Chemical Formula 1 with hydrogen iodide (HI).

8. The method for preparing diiodosilane of claim 1, wherein the reaction is performed in the presence of a mixed solvent including an ester-based organic solvent and a halogenated hydrocarbon-based organic solvent.

9. The method for preparing diiodosilane of claim 1, wherein the reaction is performed under a temperature condition of from 10 to 40° C.

10. The method for preparing diiodosilane of claim 1, further comprising:
filtering, after the reaction, iodic acid salt; and
performing distillation and purification.
